(19) United States
(12) Patent Application Publication
(10) Pub. No.: US 2004/0119689 A1
(43) Pub. Date: Jun. 24, 2004

(54) Handheld device and a method

(76) Inventor: Jerry Pettersson, Uppsala (SE)

Correspondence Address: JONES DAY, 77 WEST WACKER, CHICAGO, IL, 60601-1692, US

(21) Appl. No.: 10/618,010

(22) Filed: Jul. 11, 2003

(30) Foreign Application Priority Data
Dec. 23, 2002 (SE) 0203859-4

(51) Int. Cl. G09G 5/08

(52) U.S. Cl. 345/157; 345/160

(57) ABSTRACT

The invention relates to a handheld device (10), having a position sensing means (14) on a rear side of the device for reading position coordinate data while manually moving the device rear side (12) on a working surface (22), a display (20) on a front side of the device, whereby the position sensing means controls a cursor (24) on the display.

### PRIORITY CLAIM

This application claims the benefit of Swedish Patent Application No. 0203859-4, filed on Dec. 23, 2002.

### TECHNICAL FIELD

The present invention pertains to a handheld device and a method therefore, having a position sensing means on a rear side of the device for reading position coordinate data while manually moving the device rear side on a working surface, a display screen on a front side of the device, and a position sensing means is controlling a cursor on the display.

### BACKGROUND ART

Current hand held mobile stations such as cellular phones, personal digital assistants (PDA) with or without cellular phone capability, organizers or the like are provided more and more computing power thus resembling small hand held personal computer devices. Moreover, these devices are often equipped with bigger displays with colour features, photo and video cameras, Global Positioning System (GPS) receivers, word-processing, Internet access and other features all demanding a suitable display and high speed reliable access capabilities. Hence, there is a demand for a convenient and fast access positioning system for controlling a cursor on a display for mobile stations mentioned and others.

The U.S. Pat. No. 5,526,481 by Parks et al describes a scrolling system for a PDA including a display and a mouse integrated into the bottom surface of the PDA. A main purpose of using the mouse is to scroll in documents stored in a memory. The PDA is placed so that the mouse is positioned to face a work surface as for instance the board of a table and the mouse is manipulated to roll across the surface. While rolling over the work surface, the work surface of the PDA is regarded as a virtual display of a document to be displayed on the PDA display screen. By rolling the PDA across the surface, the mouse generates translation information and a memory controller determines the location of the PDA with respect to the document through generated view-port coordinates defining a portion of the document stored in the memory. A memory controller generates addresses to the memory location of the portion of the document, which are defined by the view-port coordinates, and the addressed portion of the document is displayed on the screen. Hereby, the screen serves as a view-port through which a portion of the document corresponding to the virtual display can be viewed.

As mentioned the overall purpose of the Park et al invention is to scroll through a document and display portions of the document stored in the memory. It is not described or taught how to utilize a computer mouse to function as a conventional PC screen cursor. Park et al teaches the use of cursor keys when scrolling a screen.

Also known in the present art, are pointing devices and front face tracking mechanisms, utilized to click on icons and scroll bars on the screen.

The park et al mouse cannot be used for game playing on the display screen of for instance a PDA or cellular phone, which constitutes a major drawback as game playing has become immensely popular with this devices. A problem with playing games relates to getting aching and sensitively fingers when rolling a trackball with a finger, which also counts for pressing cursor keys.

### SUMMARY OF THE DISCLOSED INVENTION

It is an aim of the present invention to improve the use of a display screen cursor control for mobile stations such as cellular phones, PDA's with or without cellular phone capability, organizers or the like by introducing a real computer mouse function and to eliminate some of the drawbacks with current techniques.

To achieve the aims and goals of the present invention it sets forth a handheld device, having a position sensing means on a rear side of the device for reading position coordinate data while manually moving the device rear side on a working surface, a display screen on a front side of the device, whereby the position sensing means is controlling a cursor on the display. The present invention is further comprising:

a device-to-cursor position coordinate data conversion means provided to process the device coordinate data in accordance to a preset ratio for scaled cursor coordinate data, thus defining a cursor movement which is in scaled correspondence with the device movement; and

a cursor controller means for a cursor movement across the display according to the scaled cursor coordinate data;

whereby the cursor moves on the digital display concurrently as the device is manually moved across the surface in scaled correspondence with the movement pattern of the device.

In one embodiment of the present invention the cursor is cancelled on the display thus providing movement in Arcadian display environments, such as in Arcadian games.

Another embodiment comprises that the device coordinate data is constituted of relative surface position readings in the X and Y direction axes according to a suitable coordinate system.

A further embodiment comprises that the sensing means is a trackball.

Yet another embodiment provides that the sensing means comprises a light source radiating light on the surface, wherein the radiated light reflected from the surface is received by a charge coupled device for determining coordinate data.

A still further embodiment comprises that the device is provided a digital camera, where the camera in one mode is functioning as the sensing means.

Yet still a further embodiment comprises a decision means when lifting/putting the device down it is triggered to a decision regarding an object depicted by the cursor.

Yet another embodiment comprises that a coordinate system provides coordinates in three dimensions through a third axis Z, which coordinates are determined by the camera having distance determining means.

Moreover, the present invention sets forth a method for a handheld device, having a position sensing means on a rear side of the device for reading position coordinate data while manually moving the device rear side on a working surface, a display on a front side of the device, whereby the position sensing means is controlling a cursor on the display. The method comprises the steps of:

providing processing of device coordinate data according to a preset ratio for scaled cursor coordinate data, thus defining a cursor movement which is in scaled correspondence with the device movement; and

controlling the cursor during a cursor movement across the display according to the scaled cursor coordinate data;

whereby the cursor moves on the digital display concurrently as the device is manually moved across the surface in scaled correspondence with the movement pattern of the device.

The attached set of method sub claims state further embodiments corresponding to the above described device claims.

### BRIEF DESCRIPTION OF THE DRAWINGS

Henceforth reference is had to the attached figure for a better understanding of the present invention and its examples and embodiments, wherein:

FIG. 1 schematically illustrates a mobile station rear side with a position sensing means in accordance with the present invention; and

FIG. 2 schematically illustrates a front side of a mobile station in accordance with FIG. 1.

### DETAILED DESCRIPTION OF PREFERRED EMBODIMENTS

It is an aim of the present invention to improve the use of a display screen cursor control for mobile stations such as cellular phones, PDA's with or without cellular phone capability, organizers or the like and to eliminate some of the drawbacks with current techniques. A handheld computerized device can be a laptop computer, a PDA or the like sometimes comprising cellular radio equipment or a WAP telephone device etc.

A PDA (Personal Digital Assistant) is a handheld computer that serves as an organizer for personal information.

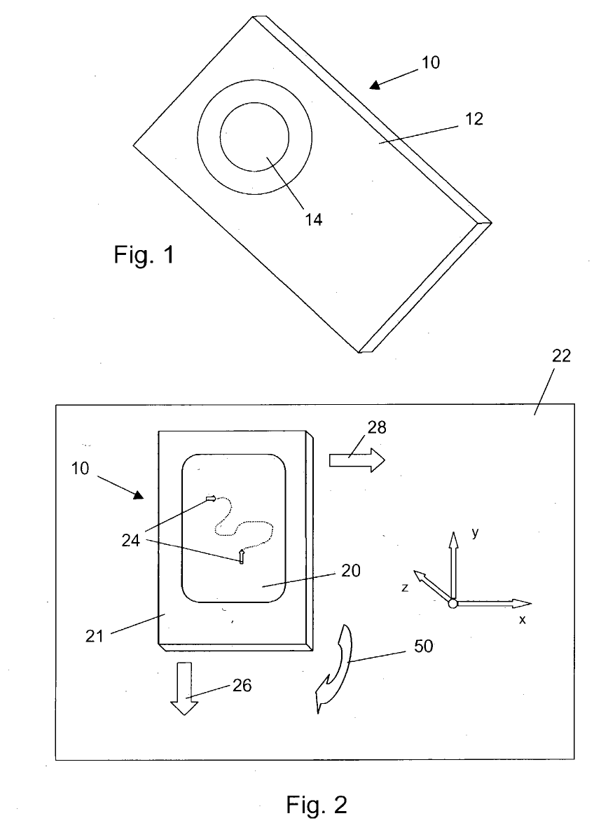

FIG. 1 depicts a mobile station 10 rear side 12. The rear side 12 has attached a position sensing means 14. Means 14 for position sensing/tracking are well known in the art and well documented in patent literature. In the U.S. Pat. No. 6,233,368 B1 by Badyal et al it is taught a CMOS digital integrated circuit (IC) chip on which an image is captured, digitized, and then processed on-chip in substantially the digital domain.

A preferred embodiment comprises imaging circuitry including a photo cell array for capturing an image and generating a representative analog signal, conversion circuitry including an n-bit successive approximation register (SAR) analog-to-digital converter for converting the analog signal to a corresponding digital signal, filter circuitry including a spatial filter for edge and contrast enhancement of the corresponding image, compression circuitry for reducing the digital signal storage needs, correlation circuitry for processing the digital signal to generate a result surface on which a minima resides representing a best fit image displacement between the captured image and previous images, interpolation circuitry for mapping the result surface into x- and y-coordinates, and an interface with a device using the chip.

The filter circuitry, the compression circuitry, the correlation circuitry and the interpolation circuitry are all embodied in an on-chip digital signal processor (DSP). The DSP embodiment allows precise algorithmic processing of the digitized signal with almost infinite hold time, depending on storage capability. The corresponding mathematical computations are thus no longer subject to the vagaries of CMOS chip structure processing analog signals. Parameters may also be programmed into the DSP's software making the chip tunable, as well as flexible and adaptable for different applications.

Another U.S. Pat. No. 5,644,139 by Allen et al discloses a scanning device and a method for forming a scanned electronic image including the use of navigation information that is acquired along with image data, and then rectifying the image data based upon the navigation and image information. The navigation information is obtained in frames. The differences between consecutive frames are detected and accumulated, and this accumulated displacement value is representative of a position of the scanning device relative to a reference. The image data is then positioned-tagged using the position data obtained from the accumulated displacement value. To avoid the accumulation of errors, the accumulated displacement value obtained from consecutive frames is updated by comparing a current frame with a much earlier frame stored in memory and using the resulting difference as the displacement from the earlier frame. These larger displacement steps are then accumulated to determine the relative position of the scanning device.

Sensor means and print-heads that are suitable for the present invention are well known in the art and described in for example U.S. Pat. No. 5,927,872 by Yamada, U.S. Pat. No. 6,233,368 B1 by Badyal et al, and U.S. Pat. No. 5,644,139 by Allen et al. Sensor means can be bought from Agilent, www.agilent.com. Techniques taught in these patent documents and numerous of others can be utilized for the position sensing in accordance with the present invention.

Other position sensing means suitable for the present invention are mouse trackballs or the like known in the art.

The present invention sets forth special position sensing means for mobile stations 10 such as cellular phones and PDA's in making use of the fairly new techniques deployed by such stations as being equipped with digital cameras. By applying image processing of camera images depicted from a working surface, data coordinates can be derived for the movement of a mobile station in x and y directions and even for the z direction by measuring height. As digital cameras are equipped with charge coupled devices (CCD), the techniques taught in herein mentioned patent documents could be deployed for signal processing of a depicted camera image. Cellular phones equipped with digital cameras are manufactured by Nokia®, Sony-Ericsson® and others.

The teaching in the Japanese patent application document JP 4336445 A2 by Nakada et al can be utilized for image processing in order to determine positions in accordance with the present invention camera application thus relying on changes in brightness between motions of the mobile station 10. Nakada et al deploy a light receiving surface of a camera positioned at the image surface of a microscope and the bright-field or dark-field illumination of an object is effected. Video signals of the camera then undergo image processing.

Measuring of height with the camera could in one embodiment be accomplished by scaling and norm images to receive coordinates that are in scale with the x and y coordinates. The coordinate system utilized for the present invention is not necessary Cartesian, other known systems such as polar coordinate systems could be utilized.

Another embodiment for deploying scale factors for height measurement with a digital camera can be achieved through a cameras zoom capability, which automatically provides scale factors from one image to another as known to a person skilled in the art.

FIG. 2 illustrates the front side 21 of a mobile station in accordance with the present invention where it is placed on a working surface 22 such as a fairly plane surface. The station 10 has a display 20 whereon a cursor 24 is depicted in accordance with the present invention. To show that the cursor is freely movable on the display screen 20 when the station is moved across the working surface 22, a possible cursor 24 movement is depicted by a dotted line. Possible directions of movement of the station 10 are schematically indicated by arrows 26 (y direction), 28 (x direction), and 50 (rotation), pointing in those directions. Also possible but not depicted in any figure is the z movement. The different directions for movements are schematically indicated by a coordinate system with x, y, and z axes.

By lifting station 10 or putting it down specific software means in the station are in one embodiment of the present invention utilized to initialise a specific function such as turning the station 10 on/off. Such software means can be connected to a switch for turning the station 10 on/off. In another embodiment the station 10 is equipped with sensors that are activated by pressure, whereby the sensor it self acts like a switch for turning the station 10 on/off. How a switching can be achieved, in many other known ways, is known to a person skilled in the art. In one embodiment of the present invention the mobile station is free from mechanical keys on the station front side 21, which conventionally are used to enter a specific function.

In one embodiment of the present invention the device-to-cursor position coordinate data x, y, z conversion means are provided to process the device coordinate data x, y, z in accordance to a preset ratio for a scaled cursor 24 coordinate data x, y, z, thus defining a cursor 24 movement which is in scaled correspondence with the device movement. A cursor 24 controller means for a cursor 24 movement across the display according to the scaled cursor 24 coordinate data x, y, z is comprised in the mobile station. The cursor 24 moves on the digital display concurrently as the device is manually moved across the surface in scaled correspondence with the movement pattern of the device as is indicated by the dotted line on the display screen 20 in FIG. 2.

It is appreciated that mobile stations in accordance with the present invention could be equipped with various electronic memories for storing of signal processed images while determining data coordinates.

A specific preferred embodiment regarding gaming with the mobile station 10 in for example Arcadian scenarios is set forth by the present invention thus the cursor 24 is cancelled on the display during movement between Arcadian display environments. The usually highlighted display screen cursor 24 is then cancelled, i.e. no longer highlighted. This embodiment provides that the cursor is absent but the function remains as such. As the cursor 24 is about to cross the visible boundary between continuous Arcadian scenarios, the scenario is smoothly forced to bias in to another Arcadian scenario.

It is appreciated that the means utilized in the present invention if not specifically are software means, hardware means or a combination of those stated.

The present invention has been described with non-limiting examples and embodiments. It is the attached set of claims that describe all possible embodiments for a person skilled in the art.

1. A handheld device (10), having a position sensing means (14) on a rear side (12) of said device (10) for reading position coordinate data (x, y, z) while manually moving said device (10) rear side (12) on a working surface (22), a display screen (20) on a front side (21) of said device (10), said position sensing means (14) controlling a cursor (24) on said display (20), by further comprising:
a device-to-cursor position coordinate data (x, y, z) conversion means provided to process the device coordinate data (x, y, z) in accordance to a preset ratio for scaled cursor (24) coordinate data (x, y, z), thus defining a cursor (24) movement which is in scaled correspondence with the device movement; and
a cursor (24) controller means for a cursor (24) movement across said display according to the scaled cursor (24) coordinate data (x, y, z);
whereby the cursor (24) moves on the digital display concurrently as the device is manually moved across the surface in scaled correspondence with the movement pattern of the device.

2. A device according to claim 1, wherein said cursor (24) is cancelled on the display thus providing movement in Arcadian display environments.

3. A device according to claim 1, wherein the device coordinate data (x, y, z) is constituted of relative surface position readings in the X and Y direction axes according to a suitable coordinate system.

4. A device according to claim 1, wherein said sensing means is a trackball.

5. A device according to claim 1, wherein the sensing means comprises a light source radiating light on said surface.

6. A device according to claim 5, wherein said radiated light reflected from said surface is received by a charge coupled device for determining coordinate data (x, y, z).

7. A device according to claim 6, wherein the device is provided a digital camera, said camera in one mode functioning as said sensing means.

8. A device according to claim 1, wherein the device is provided a digital camera, said camera in one mode functioning as said sensing means.

9. A device according to claim 1, wherein a decision means when lifting/putting said device down is triggered to a decision regarding an object depicted by the cursor (24).

10. A device according to claim 7, wherein a coordinate system provides coordinates in three dimensions through a third axis Z, which coordinates are determined by said camera having distance determining means.

11. A method for a handheld device (10), having a position sensing means (14) on a rear side (12) of said device (10) for reading position coordinate data (x, y, z) (x, y, z) while manually moving said device (10) rear side (12) on a working surface (22), a display screen (20) on a front side (21) of said device (10), said position sensing means (14) controlling a cursor (24) on said display (20), comprising the steps of:
providing processing of device coordinate data (x, y, z) according to a preset ratio for scaled cursor (24) coordinate data (x, y, z), thus defining a cursor (24) movement which is in scaled correspondence with the device movement; and
controlling the cursor (24) during a cursor (24) movement across said display according to the scaled cursor (24) coordinate data (x, y, z);
whereby the cursor (24) moves on the digital display concurrently as the device is manually moved across the surface in scaled correspondence with the movement pattern of the device.

12. A method for a device according to claim 11, wherein said cursor is cancelled on the display thus providing movement in Arcadian display environments.

13. A method for a device according to claim 11, wherein the device coordinate data is constituted of relative surface position readings in the X and Y direction axes according to a suitable coordinate system.

14. A method for a device according to claim 11, wherein said sensing is provided by a trackball.

15. A method for a device according to claim 11, wherein the sensing comprises a light source radiating light on said surface.

16. A method for a device according to claim 15, wherein said radiated light reflected from said surface is received by a charge coupled device for determining coordinate data.

17. A method for a device according to claim 16, wherein the device is provided a digital camera, said camera in one mode functioning as said sensing means.

18. A method for a device according to claim 11, wherein the device is provided a digital camera, said camera in one mode functioning as said sensing means.

19. A method for a device according to claim 11, wherein a decision means when lifting/putting said device down is triggered to a decision regarding an object depicted by the cursor.

20. A method for a device according to claim 17, wherein a coordinate system provides coordinates in three dimensions through a third axis Z, which coordinates are determined by said camera having distance determining means.
